(19) United States
(12) Patent Application Publication
(10) Pub. No.: US 2007/0288410 A1
(43) Pub. Date: Dec. 13, 2007

(54) SYSTEM AND METHOD OF USING GENETIC PROGRAMMING AND NEURAL NETWORK TECHNOLOGIES TO ENHANCE SPECTRAL DATA

(76) Inventors: Benjamin Tomkins, Longfield (GB); Craig Nimmo, Longfield (GB)

Correspondence Address: EAGLE IP LIMITED, 22/F., KWAI HUNG HOLDINGS CENTRE, 89 KING'S ROAD, NORTH POINT, omitted

(21) Appl. No.: 11/758,680

(22) Filed: Jun. 6, 2007

Related U.S. Application Data
(60) Provisional application No. 60/804,449, filed on Jun. 12, 2006.

(51) Int. Cl. G06N 3/00

(52) U.S. Cl. 706/42

(57) ABSTRACT

A signal transformation method that transforms an input signal obtained from a subject under a first value of a parameter to an output signal obtainable from said subject under a second value of said parameter is disclosed. The method creates a plurality of neural networks and subjects them to learn the mapping transformation. Genetic programming is used to evolve said plurality of neural networks by applying genetic operators to alter the configurations of said plurality of neural networks. The process of neural learning and genetic altering repeats until a predetermined number of generations is reach. The neural network that performs the mapping transformation best can be selected as the optimal neural network. This optimal neural network can be used subsequently to transform a second input signal to a second output signal for a pre-defined value of the parameter. The method of deriving the mapping transformation and the method of using the optimal neural network can be implemented as software applications that run on a data processing system.

### CROSS-REFERENCE TO RELATED APPLICATION

This application claims benefit under 35 U.S.C. § 119(e) of U.S. Provisional Application having Ser. No. 60/804,449 filed Jun. 12, 2006, which is hereby incorporated by reference herein in its entirety.

### FIELD OF INVENTION

This invention relates to signal enhancement and transformation. It is also related to a self-learning method to derive a proper mapping transformation that maps an input signal to an output signal where the output signal is an enhancement or a transformation of the input signal.

### BACKGROUND OF INVENTION

Many applications demand high quality signals. This is especially the case in mission-critical situations or in the medical field. However, it may not be possible to obtain high quality signals in practical situations due to a variety of reasons. The signal may be captured by a low-quality sensor; in noisy environmental or the signal itself is weak. Even after captured, the signal may be corrupted by noise or other unwanted interferences during the transmission and storage process. As an example in the digital photography area, the quality of a digital image depends heavily on camera equipment used, the instrumental settings as well as the environmental lighting conditions. A non-ideal lighting condition will introduce spectral bias, and in the case of poor lighting condition, some details and color may be lost in the shaded area. As for the camera equipment, the lens optics, the CCD or CMOS sensor that converts the incident light to electrical signal and the digitization process that converts the analog electrical signal to discrete values will greatly affect the image quality. This is more acute for color images as each pixel sensor captures only one of the three primary color components—red (R), green (Green) and blue (Blue). Thus the spatial resolution of a color image would be reduced and the algorithm to interpolate or smooth out the RGB values can make a big difference on the resultant image quality. In any case, the resultant image may not be the same as the original scene as perceived by human eyes.

In many practical situations, it may not be possible to take a digital photograph with an ideal aperture or speed settings due to various reasons and constraints. In other cases, one may want to change the focus area of a recorded digital image so as to study a new region of interest in more details. Hence, there is a high demand for a method that can enhance or transform an image to eliminate the noise, correct the color spectral components or to re-focus an image to another object in the scene.

Although digital image is used as an example, the need for signal enhancement for other kinds of signal or spectral data is also in great demand. This includes audio signal, time-series data, video clips and even electromagnetic waves. Often, the recorded signal is contaminated by noises and interferences either from the source or during the transmission process, and it is necessary to recover the original, ‘true’ signal from the recorded copy. Yet most of the signal enhancement techniques available today are not general-purpose signal enhancement method, but requires detailed modeling of the specific signal and noise characteristics in order to derive a customized solution for the problem at hand. This approach clearly requires much time and effort to develop, and yet a solution developed for one application can hardly be used by another.

### SUMMARY OF INVENTION

In the light of the foregoing background, it is therefore an object of the present invention to provide a flexible, general-purpose signal enhancement and transformation method that can be used for a variety of signal enhancement requirements.

Accordingly, the present invention, in one aspect, is a method of deriving a mapping transformation that transforms an input signal obtained from a subject under a first value of a parameter to an output signal obtainable from the subject under a second value of the parameter. The method comprising the steps of:
(a). creating a plurality of neural networks. Each of the neural network comprises a plurality of nodes arranged in neural layers being connected by a plurality of weighted synaptic links, and each the node further comprises a plurality of computational functions randomly selected from a plurality of functions in a plurality of function categories;
(b). storing the configurations of the plurality of neural networks to a plurality of chromosomes. The configurations of a neural network records the connections of the weighted synaptic links among nodes and the computational functions of each the nodes in at least one chromosome layer;
(c). performing a first training on the plurality of neural networks by adjusting the weighted synaptic links to learn the mapping transformation using a data set. The data set comprises a set of the input signals and a set of target signals. The target signal is obtained from the subject using a value of the parameter different from the input signal;
(d). performing a second training on the plurality of neural networks by modifying the configurations of the plurality of neural networks. It further comprises the steps of:
   i. applying genetic operators to the plurality of chromosomes. In so doing, a second plurality of neural networks with different configurations is created;
   ii. discarding neural networks in the second plurality of neural networks that do not satisfy at least one pre-defined constraint;
   iii. repeating steps (1) and (2) to replenish the discarded neural networks, and
   iv. replacing the plurality of neural networks by the second plurality of neural networks.
(e). repeating steps (c) and (d) for a pre-determined number of generations such that in each the generation the configuration of each neural network may be altered and selected flexibly by the genetic operators to derive at an optimal neural network for the mapping transformation.

In one embodiment, the signal is an image taken from an image sensor, and the parameter is the aperture setting, the shutter speed, exposure parameter, focal point, pixel density, optical lens parameters or any combination thereof. The image may be an ultra-sound image, a magnetic resonant image, a computer tomography image, an X-ray image, a gamma ray image, an infra-read image or an image from a digital camera.

In another embodiment, the signal is an audio signal taken from an audio sensor and the parameter is the spectral response of the audio sensor, the direction of audio source incoming to the audio sensor, or any combination thereof.

In yet another embodiment, the signal is a video signal with a sequence of images and an audio sensor to record an audio signal, and the parameter may be the number of images per second, the spectral response of the audio sensor, or the segmentation boundaries of the video signal. The boundaries group the video signal into video segments.

In one embodiment of this aspect of the invention, the plurality of function categories further comprises a transfer function category, a weight function category and a bias function category. Each category has a plurality of corresponding functions. The creating step further comprises the steps of choosing a transfer function from the transfer function category, choosing a weight function from the weight function category and choosing a bias function from the bias function category.

In another embodiment, the method further comprises the steps of arranging the chromosome in more than one chromosome layer. It contains
(a) a first chromosome layer with a plurality of chromosome tables to record the connections of the weighted synaptic link among nodes; each the chromosome table comprising a plurality of rows and a plurality of columns, with a non-zero table element in the chromosome table denoting that there is a connection between the row and the column while a zero entry denoting an absence of the connection, and
(b) a second chromosome layer arranged in a chromosome matrix with a plurality of rows and columns of matrix elements; each column representing one neural layer of the neural network, the first row recording the number of nodes in each the neural layer; and the other rows representing one of the function categories; and each matrix element in the other rows denoting the choice of the plurality of functions in the function category.

The present invention, in another aspect, is a method of producing a transformed output signal from a sampled input signal, the transformed output signal obtainable of a pre-selected subject under a predetermined value of a parameter, the sampled input signal obtained of the pre-selected subject under a pre-selected value of the parameter. The method comprises
(a). Obtaining the optimal neural network from the first aspect of this invention;
(b). Feeding the sampled input signal to the optimal neural network;
(c). Entering the predetermined value of the parameter to the optimal neural network, and
(d). Performing the mapping transformation to produce the transformed output signal.

In another aspect of this invention, a method is provided for deriving a mapping transformation that transforms an input signal to a target signal. The method comprises the steps of:
(a). collecting a data set. The data set further comprises a set of the input signals and a set of the target signals, with each of the target signal indicating the desired output response of the mapping transformation for the corresponding input signal;
(b). creating a plurality of neural networks. Each of the neural networks comprising a plurality of nodes arranged in neural layers. The nodes are connected by a plurality of weighted synaptic links;
(c). randomly selecting computational functions for the nodes from a plurality of functions in a plurality of function categories;
(d). storing the configurations of the plurality of neural networks to a plurality of chromosomes. The chromosomes further comprising at least one chromosome layer;
(e). training the plurality of neural networks to learn the mapping transformation by adjusting the weight values of the weighted synaptic links so that a fitness score can be optimized. The fitness score measures the mapping transformation performance of the neural network;
(f). modifying the configurations of the plurality of neural networks by repetitively performing the steps of:
   i. selecting at least one candidate chromosome from the plurality of chromosomes according to a pre-specified criteria;
   ii. generating at least one child chromosome by a genetic operator, and
   iii. applying at least one global constraint to the child chromosome and repeating steps (i) and (ii) if the child chromosome fails to satisfy the at least one constraint
   iv. so that a plurality of child chromosomes can be generated. The plurality of child chromosomes defines the configurations of the plurality of neural networks; and
(g). repeating steps (e) and (f) for a predetermined number of generations such that in each generation the configuration of each neural network may be altered and selected flexibly by the genetic operator to derive an optimal neural network for the mapping transformation.

The above method may further comprise the steps of organizing the data set into a plurality of data layers wherein a first data layer stores digitized values of the input signal and the target signal; a second data layer stores the conditions under which the digitized values are obtained and a third data layer stores additional information and data derived from the first data layer and second data layer.

In another implementation of this invention, the nodes further comprises input nodes that receives input signal; output nodes that sends out output responses, and nodes and the training step further comprising the steps of:
(a). choosing a specific training function from a plurality of training functions;
(b). inputting the set of input signals to the input nodes of the neural network;
(c). computing the set of output responses by propagating the set of input signals from the input nodes to the output nodes via the plurality of weighted synaptic links;
(d). accumulating the total error between the set of output responses and the set of target signals;
(e). invoking the specific training algorithm to adjust the weight values of the weighted synaptic links to minimize the total error;
(f). calculating the fitness score; the fitness score being related to the total error;
(g). repeating steps (b), (c), (d), (e) and (f) for a predetermined number of iterations unless the fitness score is smaller than a pre-defined criterion.

In another embodiment, a Top-B set is created to store a plurality of high performance neural networks. The training step further comprises the step of replacing at least one the high performance neural network from the Top-B set by at least one the plurality of neural networks if the fitness score of the at least one the plurality of neural network is better than the corresponding fitness score of the at least one the high performance neural network.

In another embodiment, the pre-specified criteria of selecting at least one candidate chromosome further comprises the steps of:
(a). randomly selecting a plurality of chromosomes to form a plurality of chromosome candidates; and
(b). selecting the candidate chromosome from the plurality of chromosome candidates that has the best fitness score.

In a preferred embodiment, the method further comprises the step of selecting another candidate chromosome from the plurality of chromosome candidates at random.

In another embodiment, the method further comprises the step of choosing a genetic operator from either a clone method, a mutated clone method, a crossover method or a mutated-crossover method.

In a preferred embodiment, the clone method comprises the step of copying the candidate chromosome to the child chromosome.

In another preferred embodiment, the mutated clone method further comprises the steps of:
(a). randomly selecting a plurality of table elements from the candidate chromosome;
(b). swapping the table element values between one and zero, and
(c). randomly selecting a plurality of matrix elements from the candidate chromosome;
(d). replacing the matrix element with a different value. This different value is an index to a function in the same function category that the matrix element belongs to, and
(e). copying the rest of those candidate chromosome elements not selected to the child chromosome.

In a preferred embodiment, the crossover method further comprises the steps of creating at least one child chromosome by:
(a). choosing a first candidate chromosome and a second candidate chromosome;
(b). randomly selecting a first crossover position in the first candidate chromosome; and a second crossover position in the second candidate chromosome. The first crossover position partitions the first candidate chromosome into two parts, and the second crossover position partitions the second candidate chromosome into two parts;
(c). creating the at least one child chromosome by randomly concatenating one part of the first candidate chromosome to another part of the second candidate chromosome, and
(d). reconstructing the plurality of chromosome tables of the at least one child chromosome by deleting those entries indicating connecting synaptic links to non-existing nodes in the child chromosome.

In an even more preferred embodiment, the crossover method further comprises a crossover mutation method. The crossover mutation method comprises the steps of
(a). randomly identifying at least one matrix element from the at least one child chromosome;
(b). replacing the at least one matrix element by a second matrix element with a value selected from the value found in the matrix elements of the corresponding row of the first and second chromosome candidates.

In a preferred embodiment, the mutated crossover method further comprises the steps of creating at least one child chromosome; comprising the steps of:
(a). choosing a first candidate chromosome and a second candidate chromosome;
(b). randomly selecting a first crossover position in the first candidate chromosome; and a second crossover position in the second candidate chromosome; the first crossover position partitioning the first candidate chromosome into two parts; and the second crossover position partitioning the second candidate chromosome into two parts;
(c). creating the at least one child chromosome by randomly concatenating one part of the first candidate chromosome to another part of the second candidate chromosome;
(d). reconstructing the plurality of chromosome tables of the at least one child chromosome by deleting those entries indicating connecting synaptic links to non-existing nodes in the child chromosome.
(e). randomly selecting a plurality of table elements from the at least one child chromosome;
(f). swapping the table element values between one and zero;
(g). randomly selecting a plurality of matrix elements from the at least one child chromosome, and
(h). replacing the matrix element with a different value, the different value being an index to a function in the same function category that the matrix element belongs to.

According to another aspect, the present invention is a computer system for deriving a signal transformation that transforms an input signal obtained from a subject under a first value of a parameter to an output signal obtainable from the subject under a second value of the parameter. The computer system comprises:
(a). a data collection module configured to store a data set. The data set further comprises a plurality of input signals and a plurality of target signals;
(b). a data processing module configured to prepare the data set for subsequent analysis;
(c). a neural network module that is configured to
   i. construct a plurality of neural networks. Each of the neural network comprises a plurality of nodes interconnected by a plurality of weighted synaptic links, and the configuration of the neural network is stored in a chromosome, and
   ii. train the plurality of neural networks to learn the mapping transformation using the plurality of input signals and the plurality of target signals;
(d). a fitness evaluation module configured to evaluates the performances of the plurality of neural networks in performing the mapping transformation, and stores those neural networks having high performance to a Top-B database;
(e). a genetic programming module configured to modify the configurations of the plurality of neural networks by repetitively performing the steps of:
   i. selecting at least one candidate chromosome from the plurality of chromosomes according to a pre-specified criteria;
   ii. generating at least one child chromosome by a genetic operator, and
   iii. applying at least one global constraint to the child chromosome and
   iv. repeating steps (i) and (ii) if the child chromosome fails to satisfy the at least one constraint
      so that by repetitively executing the genetic programming module, the neural network module and the fitness evaluation module, the performances of the plurality of neural networks may improve and an optimal neural network configuration can be retrieved from the Top-B database.

According to yet another aspect, the present invention is an article of manufacture for signal enhancement of a signal processing apparatus. It comprises:
(a). a data handling module configured to accept an input signal and prepare the input signal for subsequent analysis, and
(b). a neural network processing module that comprises at least one neural network. Each neural network is optimally trained to transform an input signal of a subject to an output signal of the subject according to at least one pre-determined parameter value. The at least one predetermined parameter value is connected to at least one input node of the neural network.

There are many advantages of this invention. First of all, it provides a flexible and versatile method that can derive an optimum mapping transformation to enhance, transform and manipulate a signal. The same method can be applied to many different kinds of signals, including audio signal, time-series data, images, video, and electro-magnetic waves; and is capable of performing a variety of signal enhancement and transformation tasks.

Secondly, this inventive method is capable of receiving a high-level problem statement on a particular signal enhancement task from a designer, creating an initial set of neural networks, and using the genetic programming to evolve these neural networks generation by generation to achieve the desired signal enhancement or transformation goal. All these can be achieved with minimum human intervention.

Yet another advantage of this inventive method is to produce an enhanced signal that would not have been possibly obtained by the signal capturing equipment. Examples will be given later to further illustrate this aspect.

Furthermore, the signal enhancement method can be implemented entirely in software, without the need to use specialized hardware signal capturing apparatus.

### BRIEF DESCRIPTION OF FIGURES

FIG. 1 is a neural network model.

FIG. 2 is the main flow diagram of the Polymorphic Genetic Metaheuristic Optimization System.

FIG. 3 is the data processing flow diagram.

FIG. 4 is a detailed flow diagram for creating a plurality of parent neural networks.

FIG. 5 is a tapped delay line.

FIGS. 6A and 6B show the layering arrangement of a chromosome.

FIG. 7 is a detailed flow diagram of the neural network training procedure.

FIG. 8 is a flow diagram of genetic operation procedure.

FIGS. 9A and 9B show an example of one aspect of the crossover operation in breeding a child neural network.

FIG. 10 shows the crossover mutation operation.

FIG. 11 is an exemplary data processing system.

FIG. 12 is an exemplary system block diagram of the Polymorphic Genetic Metaheuristic Optimization System.

FIG. 13 is an exemplary system block diagram of the signal mapping system.

FIGS. 14A and 14B are “before” (FIG. 14A) and “after” (FIG. 14B) exemplary digital images showing the effect of the mapping transformation.

FIGS. 15A and 15B are exemplary digital images showing another effect of the mapping transformation.

### DETAILED DESCRIPTION OF THE PREFERRED EMBODIMENTS

The following description refers to the accompanying figures which form a part hereof and which also illustrate the embodiments of the present invention. It is understood that other embodiments can be made with structural and operational changes and they will still fall into the scope of the present invention.

As used herein and in the claims, “comprising” means including the following elements but not excluding others.

The present invention teaches a method that can be implemented in software to run on a computational machine and can derive a proper mapping transformation for a specific signal enhancement and transformation task. In particular, this method applies biologically inspired computational models such as genetic programming and neural networks to find the optimum mapping transformation.

### 1. Neural Networks and Genetic Programming Computation Models

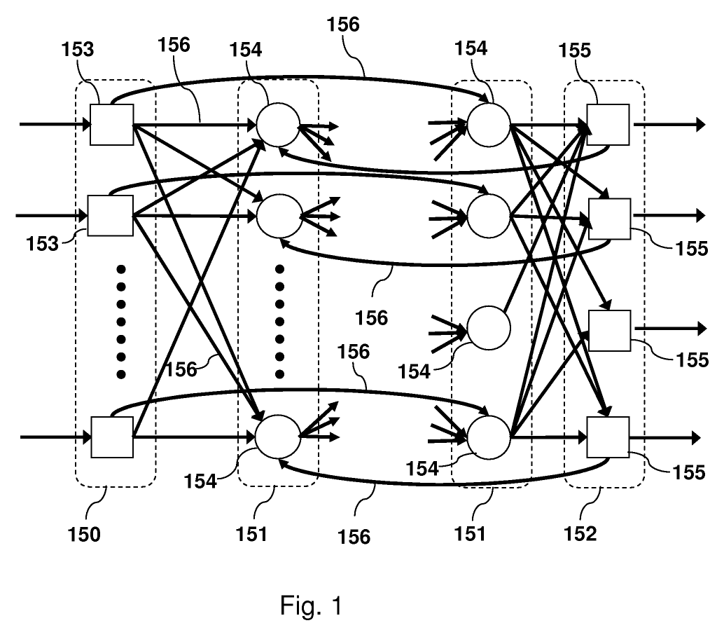

Neural networks are computational models that mimic how biological neurons process information. It can learn to recognize patterns and approximate a mapping transformation. An exemplary neural network model used in this invention is shown in FIG. 1. In this example, the neural network comprises a plurality of nodes connected by a plurality of weighted synaptic links 156. In one embodiment, nodes are arranged in layers, such as an input layer 150 and an output layer 152; and one or more hidden layers 151 between them. The first hidden layer is referred to as Layer(1), the second as Layer(2) and so on. Each layer consists of a plurality number of nodes. They are respectively the input nodes 153, hidden nodes 154 and output nodes 155. Each weighted synaptic link 156 is associated with a synaptic weight value. Synaptic links connect nodes from any layers to any other layers, including the input layer and output layer. In the present embodiment, nodes within a layer do not connect to each other. However, nodes between two layers are fully connected to one another. The input nodes 153 are connected to input port and will pass input signal to nodes in other layers via the weighted synaptic links. The signal eventually reaches the output nodes 155, and then to the output port. Each hidden node is a computational element that is equipped with a transfer function or activation function, a bias function (also known as input function) and a weight function. It computes an activation value or output value when it receives inputs from other nodes linked to it. The transfer functions may be non-linear functions and the neural network as a whole can compute a mapping transformation that maps the input signal to the output signal.

In another embodiment, the synaptic link is also associated with a time-delay element so that the input signal or the activation values of a node will only be available to the nodes that it connects to after a certain amount of time delay. Such a configuration is amenable to process dynamic or time series data. For clarity, the delay element is not shown in FIG. 1 but it should be understood that it is associated with each synaptic link.

The synaptic weights in a neural network can be adjusted via training such that the neural network can be trained to approximate any mapping transformation, the detail of which will be explained later.

In the present invention, genetic programming is used to find the best neural network configuration that can transform the input signal to the desired target signal. Genetic programming is a computational model that mimics how offspring are created from parent species. It is capable of finding a global optimum solution for a diverse variety of applications. To employ this technique according to the present invention, one needs to formulate the optimization problem in a special way and to define the following terms and functions:
Chromosome: The chromosome captures the essential parameters or attributes of the problem at hand. These parameters or attributes affect the performance of the system to be optimized. The chromosome can be represented in a computer system by various kinds of data structures such as an array of bits, a tree structure, or a multi-layer structure consists of arrays, tables or matrices in each layer.
Genetic operations: These are mathematical operations that simulate how a child chromosome can be created in the biological world. They are used to create new chromosomes from at least one parent chromosome. Some of the genetic operators include cloning, mutation and inter-marriage (i.e. crossover) operators.
Fitness function: This function evaluates a fitness score that indicates the performance of the system to be optimized. It is a function of the chromosome.

To apply genetic programming, an initial population of species is first obtained. The fitness function is used to evaluate how well these species performs on the problem at hand. Some of these species will then be chosen to breed a new generation of species. This is done by applying genetic operators to modify the chromosomes of the parent species. After a predetermined number of generations, the species that yields the best fitness score can be selected as the optimal solution for the problem at hand.

In the present invention, the species is the neural network; the chromosome is the neural network configuration; and the fitness function computes an accumulate error between a set of target signals and a corresponding set of output signals. Here, the configuration of a neural network comprises the weighted synaptic links and their connections among the layers of nodes, and also the computational functions of each node.

### 2. Method of the Present Invention

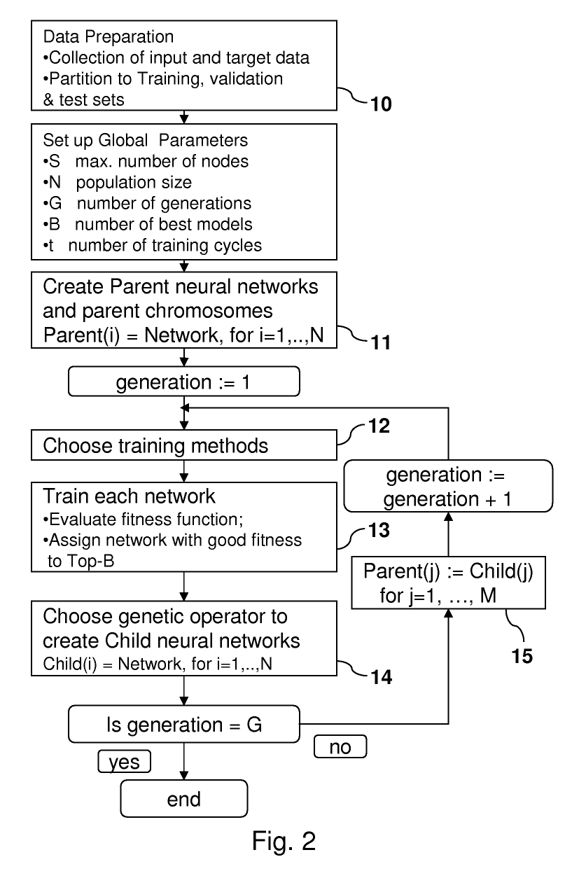

The present invention is referred to as the Polymorphic Genetic Metaheuristic Optimization System that can be implemented as a software application to run on a computer. The main flow diagram is shown in FIG. 2. The first step (step 10) is to collect a set of the input and target signal data, and to prepare the data set for subsequent processing. Since this inventive method is to find a mapping transformation that can transform the input signal to the target signal as faithful as possible, the data collected is an implicit, high-level problem statement that the designer instructs this system to achieve.

After the data preparation step (step 10), a set of global parameters are set up for subsequent training purposes as shown in Table 1.

TABLE 1

| Parameter | Description |
|---|---|
| S | Maximum number of nodes allowed for each neural network |
| N | Number of neural networks in a population |
| G | Number of generations |
| B | Number of best models |
| T | Number of training cycles for neural network training |

Control is then passed on to step 11 to create a population of N parent neural networks. The configuration of each parent neural network is recorded in a corresponding parent chromosome (not shown in FIG. 2), which consists of the following set of parameters: the number of layers, the number of nodes in each layer, the synaptic connections among these nodes, as well as the transfer function, the bias function and the weight function of each node. This set of parameters is chosen in random in the initial construction of the parent neural network population.

The whole population of parent neural networks will then be subjected to a first training in steps 12 and 13. In step 12, a training function is selected from a pool of possible training methods. The training function adjusts the synaptic weights of a neural network so that it learns the mapping transformation in step 13. During the training process, a fitness score that indicates how well the neural network performs the mapping transformation is computed in each training cycle. Those parent neural networks with fitness scores satisfying pre-determined criteria are recorded in the Top-B set. After the first training, control is passed on to step 14 for a second training. Here the configurations of the parent neural networks are modified by genetic operators to generate a plurality of child neural network configurations. Those child neural networks that satisfy at least one global constraint are selected to replace the parent neural networks in step 15. Steps 12, 13 and 14 are then repeated until the number of generations reaches G, one of the global parameters. Afterwards, an optimal neural network that achieves the best fitness score can be retrieved from the Top-B set.

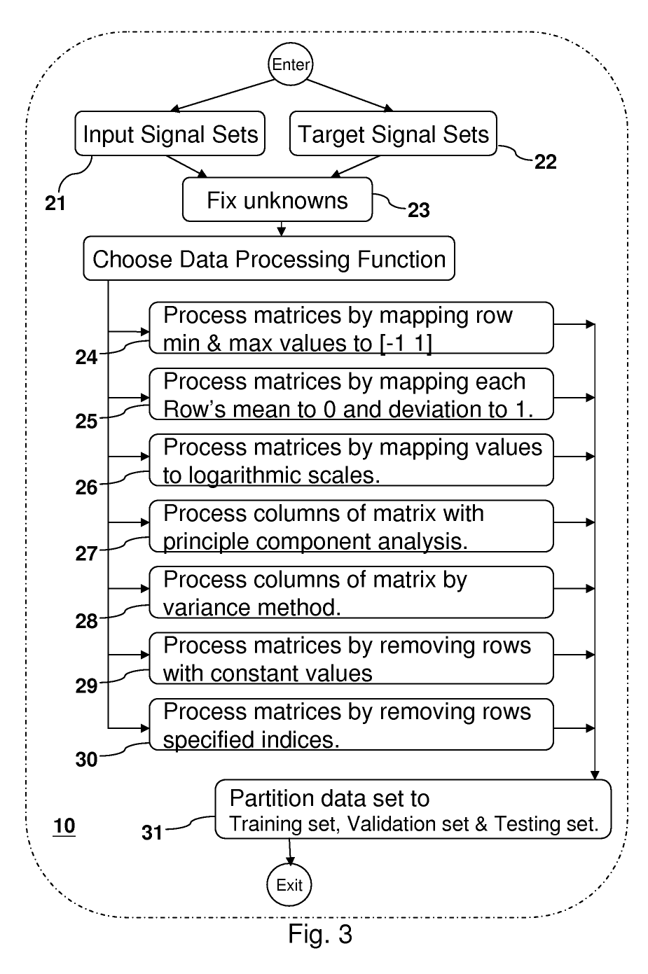

In one embodiment, the data process step 10 for image data is further elaborated in FIG. 3. Such data can be represented in data matrices. Firstly, a large set of input signal data and target signal data set are collected in steps 21 & 22. In one embodiment, the image data is organized in three data layers. The first data layer is the pixel values from the digital camera sensor such as the RGB (red, green and blue) values. The second data layer stores the information about the digital camera such as the image size, lens type being used . . . etc, as well as the camera settings on which the image is taken. The latter includes the ISO value, the aperture settings, the shutter speed, the focal point, pixel density, optical lens parameters and other relevant camera settings. The third data layer stores the actual scene being surveyed, and information derived from the first and second data layers. Examples of such information are the mean pixel value of each RGB channel, the histogram of the image, or other values obtained from applying image processing techniques to the data layers.

After steps 21 and 22, control is passed to step 23 to inspect the correctness of the data and to fix any unknown values in these signal data sets. As an example, those rows of a matrix with unknown value(s) are each replaced by two rows. The first row contains the original row, with the unknown value replaced by the mean value of the row, and the second row contains values of either one and zero, with a one assigned to those column positions that have unknown values in the first row and zero otherwise. Afterwards, one of the following data processing functions can be selected to operate on the matrices:
1. Determining the minimum and maximum values in each row and scaling the elements in each row to a value between −1 and +1 (step 24);
2. Determining the mean and variance values in each row and scaling the elements in each row so that after scaling, the mean value becomes 0 and the variance becomes 1 (step 25);
3. Converting the matrix elements in logarithmic scale (step 26);
4. Processing columns of matrix with Principle Component Analysis (PCA) (step 27);
5. Determining the variance values of each column and scaling each column element such that after scaling, the variance becomes 1 (step 28);
6. Removing a row of matrix with constant value (step 29);
7. Removing rows of matrix with specified indices (step 30);

In one implementation, one of these data processing steps is chosen to process the data matrices. In an alternative implementation, more than one data processing steps can be applied to a data matrix.

Afterwards, both the input signal data and the target signal data are partitioned into three sets in step 31—the training set, the validating set and the testing set; each of these sets comprising a plurality of input signals and a corresponding number of target signals.

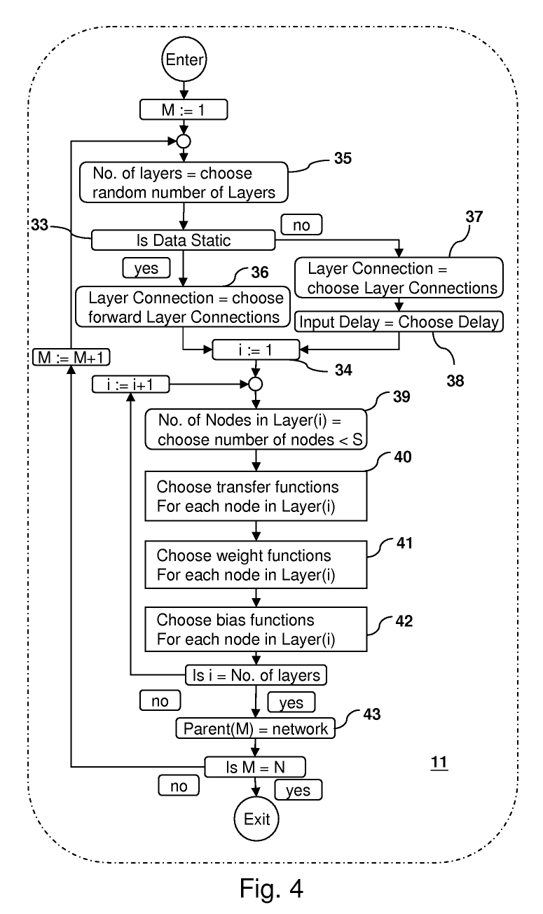

The next step is to create a population of N neural networks one by one as shown in FIG. 4 (for ease of description, this first plurality of neural networks is also referred to as the parent neural networks to distinguish them from a second plurality of neural networks that are created by the genetic operations described below and are referred to as the child neural networks). For each parent neural network, the number of input nodes and output nodes are usually determined by the problem at hand; and will be the same for all the N parent neural networks. However, the number of hidden layers is chosen at random in step 35. Step 33 is to check whether the data set is static (i.e. not time-series data). If the data is static, control is passed to step 36. Otherwise, control is passed to step 37 to handle dynamic and time-series data.

Both steps 36 and 37 are to specify the synaptic connections among the layers. In step 36, only ‘forward connections’ are allowed. This means that Layer(i) can connect to Layer(j) only if i<j; the input layer can connect to any layer but the output layer does not connect to any layer. In contrast, there is no such restriction for step 37, and nodes in one layer can connect to nodes in any other layer—including looping back to its own layer. However, nodes within each layer do not inter-connect with each other in both cases.

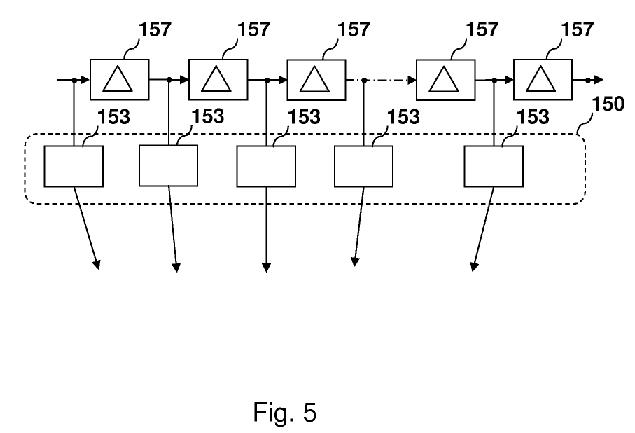

As described previously, step 36 is for processing static data. After this step, control is passed on to step 34. For dynamic and time-series data, step 37 not only chooses the synaptic connections among layers but also connect the input signals to the input nodes via a tapped-delay line as shown in FIG. 5. The input signal enters the tapped-delay line from the left, reaches the next input node after a delay element 157, and propagates onward. In this case, each synaptic link, as well as the tapped delay line, is associated with a delay element that holds the signal for a certain amount of time steps before releasing it for subsequent processing. The amount of delay in each delay element is determined in step 38. In one embodiment, the amount of delay in each layer is the same. After this step, control is passed on to step 34 as well.

Step 39 is to choose the number of nodes in each hidden layer. In one implementation, the total number of hidden nodes in the entire neural network is restricted to be less than the global parameter S. This restricts the size of the overall neural network such that the computation resources (memory and training time) will not be overly stretched. Moreover, each hidden node has a plurality of functions selected from a plurality of function categories. In one embodiment, each hidden node has a transfer function (also known as the activation function) selected from a transfer function category, a bias function selected from a bias function category and a weight function selected from a weight function category. Nodes in the same layer share the same functions. The transfer function is chosen in step 40, the weight function in step 41 and the bias function in step 42. These three steps are repeated for each hidden layer until all parameters of this parent neural network are fully defined. The current neural network is then assigned as Parent(M) in step 43. Afterwards, another parent neural network is created in the same way until all N parent neural networks are created as shown in the outer loop of FIG. 4.

In one implementation of the present invention, the following symbols and equations are used to describe the neural computation of the nodes:

### Let w_{n,m,i,j} be the weight value for the connection from node(m) of layer(lₙ) to node(j) of layer(i) where

layer(lₙ) is any input or hidden layer such that lₙ≠1ₖ where n≠k

layer(i) is any hidden layer,

1≦n≦Nᵢ,

1≦j≦Jᵢ,

1≦m≦Mₗ_{ₙ},

and where

Nᵢ is the number of layers connecting to layer(i)

Jᵢ is the number of nodes in layer(i)

Mₗ_{ₙ} is the number of nodes in layer(lₙ)

### Let a_{i,j,t,s} be the activation value outputted from node(m) of layer(lₙ) at time step t for the set of data s input to the network, (e.g. set of data for one individual in a training set):

a_{i,j,t,s}=f(y(x_{i,j,t,s},bᵢ)) [Eqn. 1]

where
f(.) is the transfer function
y(.,.) is the biased signal strength function that will be defined in Eqns. 3 & 4.
x_{i,j,t,s} is the signal strength value of node (j) in layer (i) from the weight function on time step t for data set s
bᵢ is the bias value for layer (i)
   The weight value x_{i,j,t,s} is computed according to equation:

x_{i,j,t,s}=g(w_{n,m,i,j},a_{n,m,t,s}) [Eqn. 2]

where

g(.) is the weight function

Step 40 is to randomly select one of the transfer functions in Table 2 for all nodes in Layer(i):

TABLE 2
Transfer Functions

| Index | Name | Transfer Function Equation |
|---|---|---|
| 1 | Competitive Transfer Function | The activation values of all the nodes in the layer are |
| | | evaluated and compared. The node having the highest |
| | | activation value is declared as winner and is assigned to |
| | | a value a while others are set to zero, where a is a pre- |
| | | defined real value. |
| 2 | Hard Limit Transfer Function | $f ( x ) = \{ \begin{matrix}0 & x < 0 \\ 1 & 0 \leq x\end{matrix}$ |
| 3 | Symmetric Hard Limit TransferFunction | $f ( x ) = \{ \begin{matrix}- 1 & x < 0 \\ 1 & 0 \leq x\end{matrix}$ |
| 4 | Log-Sigmoid Transfer Function | $f ( x ) = \frac{1}{1 - {e}^{( - x )}}$ |
| 5 | Inverse Transfer Function | $f ( x ) = \frac{1}{x}$ |
| 6 | Positive Linear Transfer Function | $f ( x ) = \{ \begin{matrix}0 & x \leq 0 \\ x & 0 < x\end{matrix}$ |
| 7 | Linear Transfer Function | f(x) = x |
| 8 | Radial Basis Transfer Function | f(x) = e^{(-x}^{²⁾} |
| 9 | Saturating Linear TransferFunction | $f ( x ) = \{ \begin{matrix}0 & x \leq - 1 \\ x & - 1 < x and x < 1 \\ 1 & 1 \leq x\end{matrix}$ |
| 10 | Symmetric Saturating LinearTransfer Function | $f ( x ) = \{ \begin{matrix}- 1 & x \leq - 1 \\ x & - 1 < x and x < 1 \\ 1 & x \leq 1\end{matrix}$ |
| 11 | Softmax Transfer Function | $f ( x ) = \frac{{e}^{x}}{{\sum }_{j = 1}^{n} {e}^{x}}$ |
| 12 | Hyperbolic Tangent SigmoidTransfer Function | $f ( x ) = \frac{1}{1 - {e}^{( - 2 x )}} - 1$ |
| 13 | Triangular Basis Transfer Function | $f ( x ) = \{ \begin{matrix}0 & x \leq - 1 \\ x & - 1 \leq x and x < 0 \\ - x & 0 \leq x and x < 1 \\ 0 & 1 \leq x\end{matrix}$ |

In essence, the Competitive Transfer Function in Table 2 adopts the ‘winner-take-all’ strategy whereby only the winner node has non-zero output value while the rest are set to zero.

Similarly, step 41 is to randomly select one of the weight functions in Table 3 for all nodes in Layer(i):

TABLE 3
Weight Functions

| Index | Name | Weight Function Equation |
|---|---|---|
| 1 | EuclideanDistanceWeightFunction | ${x}_{i , j , t , s} = \sqrt{{\sum }_{m} {( {w}_{n , m , i , j} - {a}_{n , m , t , s} )}^{2}}$ |
| 2 | Dot ProductWeightFunction | ${x}_{i , j , t , s} = {\sum }_{m} ( {w}_{n , m , i , j} * {a}_{n , m , t , s} )$ |
| 3 | ManhattanDistanceWeightFunction | ${x}_{i , j , t , s} = {\sum }_{n , m} \vert {w}_{n , m , i , j} - {a}_{n , m , t , s} \vert \\ it can also be written as$ |
| | | ${x}_{i , j , t , s} = {\sum }_{n , m} \sqrt{{( {w}_{n , m , i , j} - {a}_{n , m , t , s} )}^{2}}$ |
| 4 | NegativeDistanceWeightFunction | ${x}_{i , j , t , s} = - \sqrt{{( {\sum }_{n , m} ( {w}_{n , m , i , j} - {a}_{n , m , t , s} ) )}^{2}}$ $it can also be written as$ |
| | | ${x}_{i , j , t , s} = - \sqrt{{( {\sum }_{n , m} ( {w}_{n , m , i , j} - {a}_{n , m , t , s} ) )}^{2}}$ $it can also be written as$ |
| 5 | NormalizedDot ProductWeightFunction | ${x}_{i , j , t , s} = \frac{{\sum }_{n , m} ( {w}_{n , m , i , j} * {a}_{n , m , t , s} )}{{\sum }_{n , m} \sqrt{{a}_{n , m , t , s}^{2}}}$ $it can also be written as$ |
| | | ${x}_{i , j , i , s} = \frac{{\sum }_{n , m} ( {w}_{n , m , i , j} * {a}_{n , m , t , s} )}{{\sum }_{n , m} \vert {a}_{n , m , t , s} \vert}$ |
| 6 | ScalarProductWeightFunction | ${x}_{i , j , t , s} = {\sum }_{n , m} {w}_{n , m , i , j} * {a}_{n , m , t , s}$ $where {w}_{n , m , i , j} ≡ {w}_{q , p , i , j} for all m , n , p and q$ $it can also be written as$ |
| | | ${x}_{i , j , t , s} = {\tilde{w}}_{i , j} * {\sum }_{n , m} {a}_{n , m , t , s}$ $where {\tilde{w}}_{i , j} is the weight constant for all going to node ( i , j ) .$ |
| 7 | ConvolutionWeightFunction | ${x}_{i , j , t , s} = {\sum }_{n , m} ( {w}_{n , j + 1 - m , i , j} * {a}_{n , m , t , s} ) , ∀ m \leq j$ |

Note: for the convolution weight function, there are no “real” synaptic link connections. Instead a matrix operation is performed between the activation matrix and the weight matrix. Here, the weight matrix is dependent upon the numbers of layers connecting to layer(i) and the number of nodes in layer(i)

Similarly, step 42 is to randomly select either the product bias function or the sum bias function for all nodes in Layer(i). For the product bias function, the biased signal strength function y becomes:

y(x_{i,j,t,s},bᵢ)=x_{i,j,t,s}*bᵢ [Eqn. 3]

and for the sum bias function, the biased signal strength function y becomes:

y(x_{i,j,t,s},bᵢ)=x_{i,j,t,s}+bᵢ [Eqn. 4]

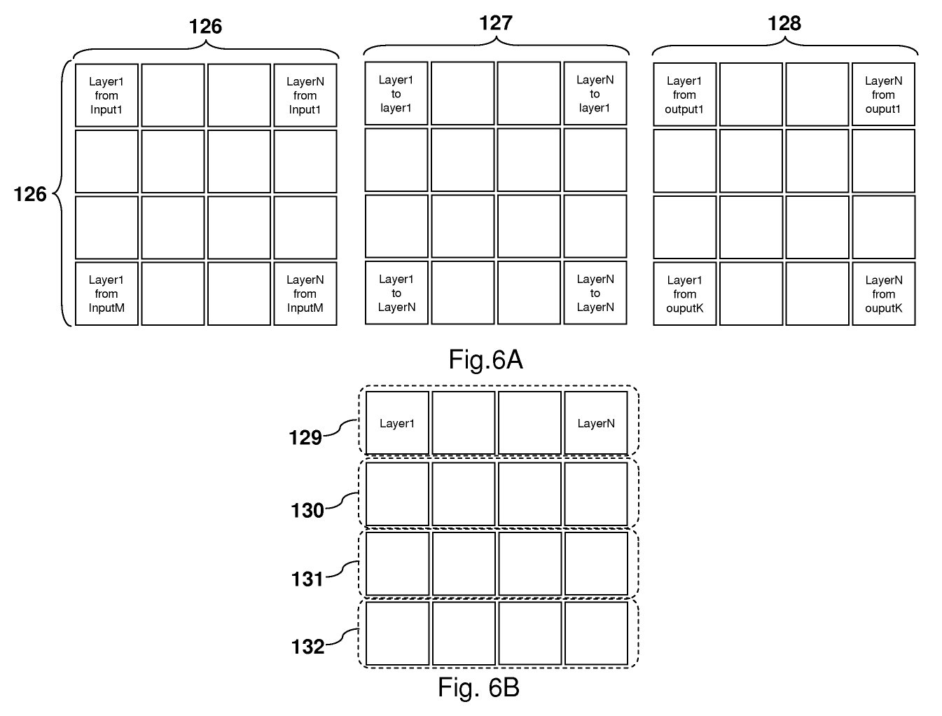

The full set of parameters that defines a parent neural network is stored in a corresponding parent chromosome. In one implementation, the parent chromosome is arranged in two chromosome layers as shown FIGS. 6A and 6B. The first chromosome layer stores the synaptic connection information and comprises three sections. Each section is arranged as a two-dimensional table as shown in FIG. 6A; and each element in the table (also referred to as table element) takes on binary values of either zero or one. The value one indicates that the corresponding row has synaptic connection(s) to the corresponding column; while the value zero means there is no connection. Table 126 has P rows and Q columns; where P is the number of input nodes and Q is the number of hidden layers in this neural network. Thus a non-zero table element in row i and column j of table 126 indicates that input node(i) is connected to all nodes in Layer(j). Likewise, table 127 is a Q by Q table, indicating the synaptic connections between the hidden layers. In this embodiment, if an element in this table is set to one, the nodes between these two hidden layers are always fully connected. Table 128 is a Q by K table, where K is the number of output nodes. This table indicates the synaptic connections between nodes in all the hidden layers to the output nodes.

The second chromosome layer is shown in FIG. 6B, where it records the attributes of each hidden layer. It is represented by a matrix of 4 rows and N columns, where N is the number of hidden layers. Each element in the matrix is referred to as a matrix element. The matrix elements in the first row 129 store the number of nodes in each hidden layer. Likewise, matrix elements in row 130 store the weight functions, those in row 131 stores the bias functions and those in row 132 stores the transfer functions of each hidden layer respectively. In one embodiment, alphabetic representation is used as an index to the selected functions. In an alternate embodiment, numerical values can also be used. Notice that in this embodiment, nodes in the same hidden layer use the same transfer function, weight function and bias function.

After all the M parent neural networks are created in step 11 as shown in FIG. 2, control is passed to the main training loop to evolve the parent neural networks for multiple generations in order to obtain an optimum mapping transformation. Starting with generation=1, the program loop first selects a training method in step 12. In one embodiment, this step is to choose a training function from Table 4:

TABLE 4
Training Functions

| Index | Name |
|---|---|
| 1 | Batch training with weight and bias learning rules |
| 2 | Broyden-Fletcher-Goldfarb-Shanno quasi-Newton backpropagation |
| 3 | Bayesian regularization |
| 4 | Cyclical order incremental update |
| 5 | Powell-Beale conjugate gradient backpropagation |
| 6 | Fletcher-Powell conjugate gradient backpropagation |
| 7 | Polak-Ribiére conjugate gradient backpropagation |
| 8 | Gradient descent backpropagation |
| 9 | Gradient descent with adaptive learning rule backpropagation |
| 10 | Gradient descent with momentum backpropagation |
| 11 | Gradient descent with momentum and adaptive learning rule |
| | backpropagation |
| 12 | Levenberg-Marquardt backpropagation |
| 13 | One step secant backpropagation |
| 14 | Resilient backpropagation |
| 15 | Scaled conjugate gradient backpropagation |
| 13 | Sequential order incremental training with learning functions |
| 14 | Random order incremental training with learning functions |

In the present embodiment, this set of training functions is adapted from a commercial package—the Matlab Neural Network Toolbox. A detailed description of each training function can be found in the manual—“Neural Network Toolbox: For Use with MATLAB” by Howard Demuth, Mark Beale” by Mathworks Inc.

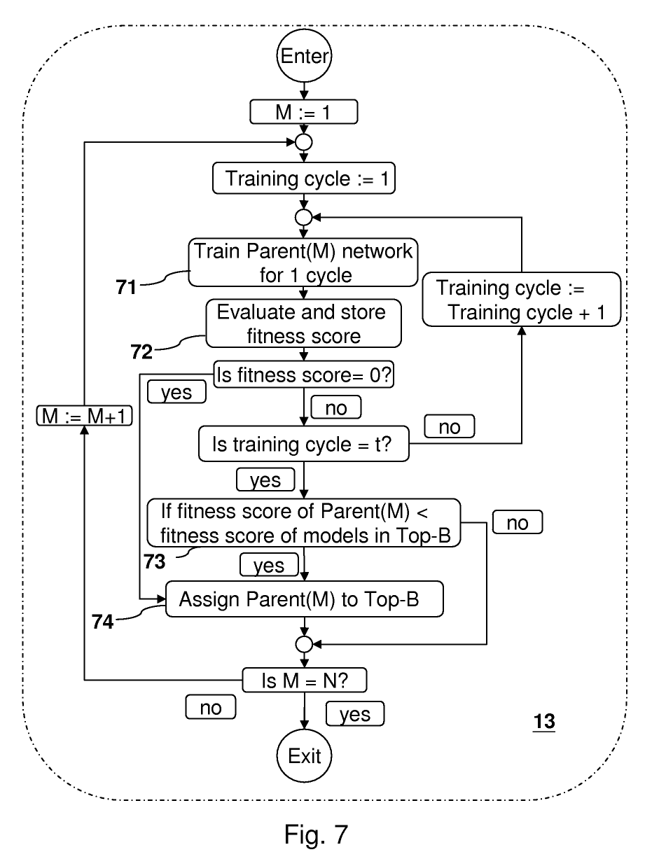

After selecting the training method, each parent network is to undergo training in step 13. The training procedure is further described in FIG. 7. Starting from the first parent neural network (M=1), the neural network Parent(M) is trained for one cycle as shown in step 71. This is done by feeding the input signal data from the training set to Parent(M), computing the output responses of Parent(M), comparing the output responses against the corresponding target signal data from the training set, and accumulating the error. The selected training function is then invoked to modify the synaptic weights. Afterwards, the validating set is used to check if the newly-trained Parent(M) is not over-trained. The rationale for doing so will be explained in the following paragraph. Subsequently, the testing set is used. The same procedure of sending the input signal data to the Parent(M) neural network, comparing the output responses against the corresponding target signal data and accumulating errors are repeated on the testing set. The accumulated error on the testing data set is the testing error of this Parent(M) neural network. This testing error is then used to compute a fitness score in step 72. In one embodiment, the error is the mean square error. The fitness score can be equated to the testing error or it can be a monotonic increasing function of the testing error.

The use of the validating set in each training cycle is to ensure that the Parent(M) neural network is not over-trained. It has been observed experimentally that a neural network can perform very well in training set of data but poorly on independent testing set. This is caused by over-training. The validating set also contains input signal data and target signal data, and the same procedure used to obtain the testing error is also used to compute the validation error. The validation error is computed and recorded after each training cycle and is recorded. After training the Parent(M) neural network for many cycles, if the validation error at the present cycle is found to be worse than the previous cycle, then the Parent(M) is declared to be over-trained. At that point, training will stop and the results of the present cycle is discarded.

Referring back to FIG. 7, if the fitness score of Parent(M) is zero, then this neural network performs the mapping transformation perfectly well so it exists the training loop and jumps to step 74 immediately. Otherwise, the training procedure is repeated for another cycle, until the total number of cycles reaches a global training parameter t, or until the Parent(M) is over-trained as mentioned above.

After exiting the neural training loop, control is passed to step 73 to check if the fitness score of this newly trained Parent(M) neural network is less than any entry in the Top-B set. The Top-B set stores those neural networks that yield the best set of fitness scores so far. In this embodiment, the size of this set is determined by the global parameter B; and the lower the fitness score, the better the neural network in performing the mapping transformation. Initially, this set is empty. Hence if the Top-B set is not full, or if the fitness score of the newly trained neural network is lower than one of the entries in Top-B, then the Parent(M) will be assigned to the Top-B set in Step 74. This action may result in a replacement of an existing entry in Top-B that has the highest fitness score in this set. In essence, the Top-B set is the ‘hall of frame’ of all the neural networks that perform well for the mapping transformation task at hand.

After training one parent neural network, the program loops back to begin training another one, until all N neural networks are fully trained.

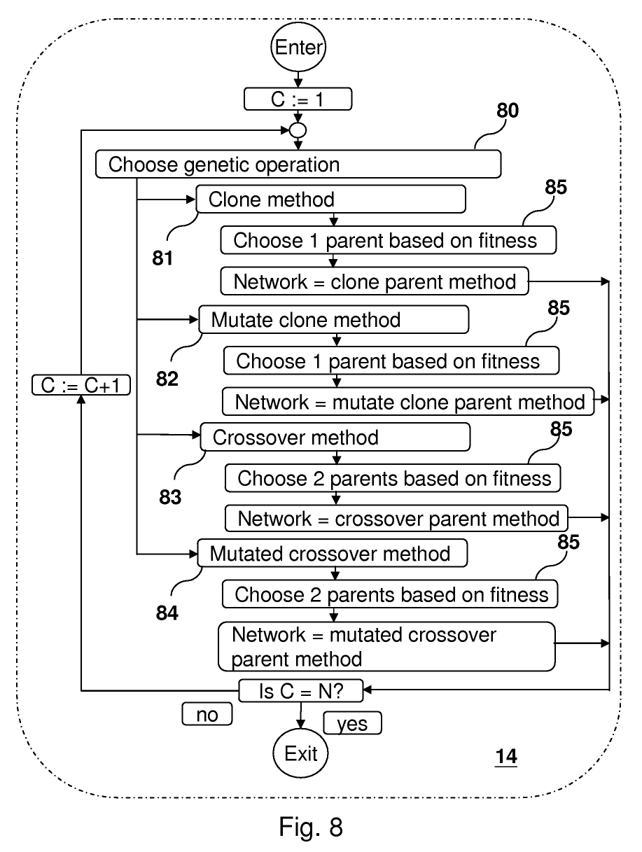

After neural training (step 13 in FIG. 2), the next step is to evolve this set of parent neural networks for another generation so that their offspring may achieve better fitness performance. This is done by choosing a genetic operator to breed a set of child neural networks in step 14. The details of this step are shown in FIG. 8

The first step in FIG. 8 is to randomly choose a genetic operation (step 80). There are four operations to choose from in the present implementation as shown in FIG. 8. They are chosen with different probabilities as shown in the following table:

TABLE 5
Pobability of Choosing a Genetic Operation

| Genetic Operation | Probability |
|---|---|
| Clone method 81 | 30% |
| Mutated clone method 82 | 10% |
| Crossover method 83 | 50% |
| Mutated crossover method 84 | 10% |

If the clone method 81 is chosen, it first chooses a parent neural network from the population (step 85). The process of selecting parent neural network will be discussed in more details in a later section. The cloning method is to copy the parent chromosome to a child chromosome, thus producing a child neural network that is identical to the parent.

Another genetic operator is the mutated clone method operation 82. After choosing a parent neural network in step 85, the mutated clone method operation 82 will select at least one chromosome element (also referred to as a gene) within the parent chromosome, and replace its content with another value. The actual mutation operation performs differently depending on whether the gene is in the first or the second chromosome layer. Since a gene in the first chromosome layer takes on a binary value that indicates synaptic connections among neural layers, the mutation operation alters this value to either make or break the connections. For a gene in the second chromosome layer, the mutation operation selects a different value or function from the same class. As an example, if the gene specifies a transfer function of a particular node, then the mutated clone method selects a different transfer function from the pool of all available transfer functions in the transfer function category. Similarly, the same rule applies to other genes in this layer. In one implementation, 50% of the parent chromosome may be changed. After a successful mutation operation is found, the mutated parent chromosome is copied to a child chromosome, thus a child neural network can be created.

A third genetic operation is the crossover method 83. Here two different parent neural networks are selected, denoted as A and B in the following discussion. A crossover point is randomly selected for each of these chromosomes. These crossover points partitions both parent chromosomes into two parts. The crossover operation then creates a child chromosome by randomly selecting one part from A, one part from B, and merging them together.

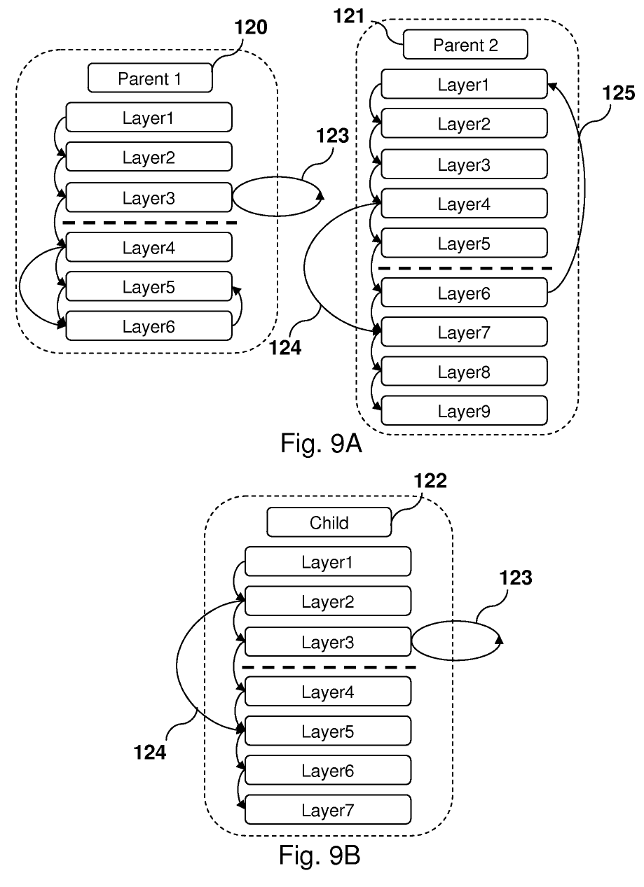

The child chromosome C defines a new neural network configuration. An attempt is made to try to preserve the structures of the parent neural networks as much as possible when copying to the child neural network. This is further illustrated in FIGS. 9A and B by way of an example. FIG. 9A shows the two selected parent neural networks—Parent 120 and Parent 121. Parent 120 has 6 layers while Parent 121 has 9 layers. The crossover points are selected after Layer(3) of Parent 120 and after Layer(5) of Parent 121. The arrows show the synaptic connections between layers. Note that Layer(3) of Parent 120 has synaptic connection back to itself as indicated in loop 123. Also, Layer(7) of Parent 121 has inputs from Layer(6) as well as from Layer(4) as indicated by link 124. In addition, link 125 connects Layer(6) back to Layer(1). After the crossover operation, the child 122 inherits the first 3 layers from Parent 120, and the last 4 layers of Parent 121. The loop connection 123 of Layer(3) in child 122 is inherited from Parent 120 as expected. As for Layer(5) of child 122 which is inherited from Layer(7) of Parent 121, it is now connected to both its previous layers—Layer(4), and also to Layer(2), i.e. three layers before itself through link 124. On the other hand, the equivalence of link 125 no longer exists in child 122 since it would have to connect to a layer that no longer exists in this child neural network. Thus in this embodiment, the crossover method 83 attempts to preserve the neural network structures of both parents as much as possible in constructing the child neural network 122.

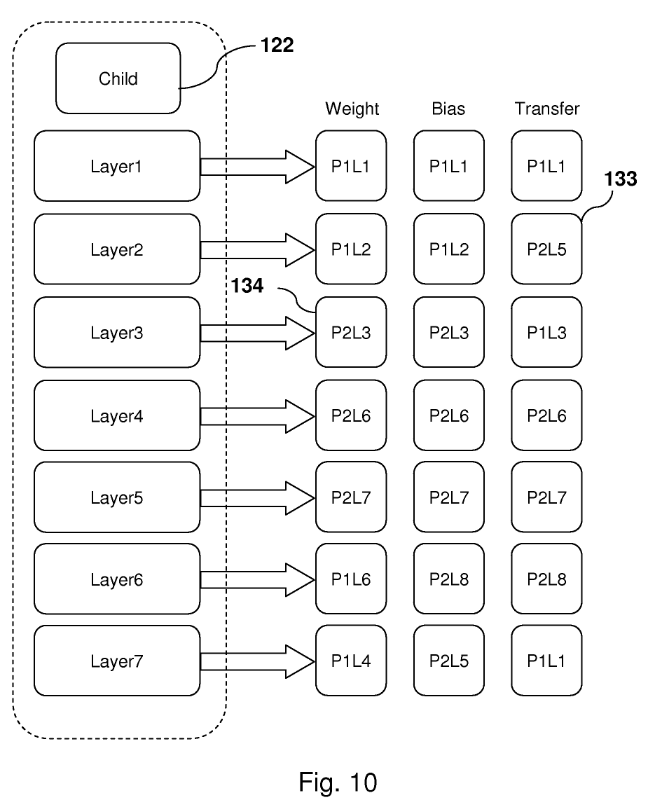

In a preferred embodiment, mutation also occurs after the crossover method 83. This crossover mutation is different from the one described above and is, for example, applicable to modify the second chromosome layer of the child chromosome. In essence, the choice of the function in each function category for all the nodes in a neural layer can be changed—but only to functions that are used by both parents. This is explained more clearly in FIG. 10, using the exemplary case of FIG. 9.

Firstly, we use the notion of ‘PmLn’ to denote ‘Parent(M) Layer(n)’ so ‘P1L2’ denotes Parent(1) Layer(2). FIG. 10 shows that the weight function, bias function and transfer function of Layer(1) of child 122 are all inherited from parent 120, while those of Layer(4) all inherited from parent 121. However, the transfer function 133 of Layer(2) of child 122 is inherited from Layer(5) of parent 121 (P2L5), and the weight function 134 of Layer(3) is inherited from Layer(3) of parent 121 (P2L3). Similarly, there are other mutation changes in the child chromosome as shown in this figure. In the present embodiment, the choice of the replacement functions can only come from both parent chromosomes. This is different from the mutated clone method described above. In one implementation, about 30% of these functions will be modified. Also, the part of the child chromosome corresponding to a parent chromosome with a higher fitness score (i.e. poor performance) will have a higher probability of being mutated. In one preferred implementation, this probability is 0.7 for the poor performing parent compared to 0.3 for the better performing parent.

The fourth genetic operation is the mutated crossover method 84. This method essentially combines the mutation and the crossover operations together. Initially, two parent chromosomes are selected in step 85, then the crossover operation as mentioned in the previous paragraph is performed to create one child chromosome. Afterwards, the mutation operation similar to step 82 is applied to the newly created child chromosome. Note that mutation here applies to both chromosome layers and all functions in a function category can be selected for mutation, as in the case of the mutated clone method.

After a child chromosome is created by any of the genetic operations, it is subjected to additional checks to see if the child neural network satisfies at least one global constraint. In the present embodiment, it checks to ensure that the total number of nodes in the child neural network configuration is less than a global parameter S. Otherwise, the child chromosome is discarded. This global constraint ensures that the child neural network will not grow in size from generation to generation. By eliminating child chromosomes that are unlikely to perform well in an early stage, the time required to derive an optimal neural network can be much reduced.

The method of choosing the parent neural networks (step 85) for performing the genetic operation is further explained here. Firstly, four parent neural networks are selected at random as potential candidates. The one that has the highest fitness score is chosen as the candidate chromosome for the genetic operation. As for those genetic operations that require two parent neural networks, a second candidate chromosome is selected randomly from the remaining three candidates.

### 3. Hardware and Software Implementation Details

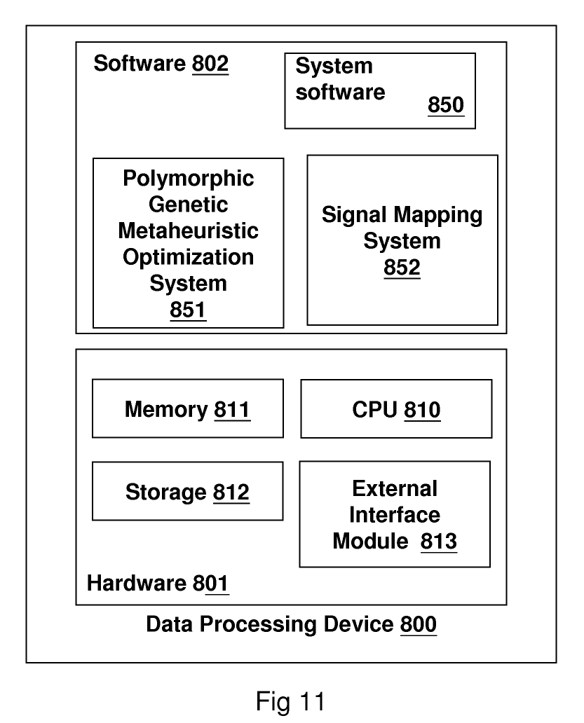

In one implementation, the present invention can be implemented as a software application that runs on an exemplary data processing system 800 as shown in FIG. 11. In the present embodiment, the data processing system 800 is a single processor personal computer. In alternative embodiments, this data processing device is a computer server, an embedded system, a multi-processor machine, a grid computer, or an equivalent computer system thereof. The hardware components in the present embodiment further comprises a Central Processing Unit (CPU) 810, memory 811, storage 812, and external interface module 813 which serves to communicate with external peripherals.

CPU 810 can either be a single microprocessor or multiple processors combined together. In an alternative embodiment, it can be a multi-core processor, including a single multi-core processor or multiple multi-core processors, or a combination thereof. Memory 811 can include read-only memory, random-access memory or other memory technologies, singly or jointly combined. Storage 812 includes persistence storage such as magnetic hard disk, optical storage devices such as CD-ROM, and semiconductor storage devices such as flash memory cards, or other storage technologies, singly or in combination.

The external interface module 813 further comprises input ports, output ports as well as network ports. In a preferred embodiment, one of the input ports is used to receive input signal and one of the output ports is used to send out the output signal. Another output port can be used to control the equipment of which the input signal is obtained. In a preferred embodiment wherein the input signal is a digital image from a digital camera, this output port can be used to control the digital camera's settings. In an alternative embodiment, the input signals can be stored in an external storage device and transferred to this data processing device 800 via the network port.

Software 802 further comprises system software 850, and application software such as the Polymorphic Genetic Metaheuristic Optimization system 851 and the signal mapping system 852.

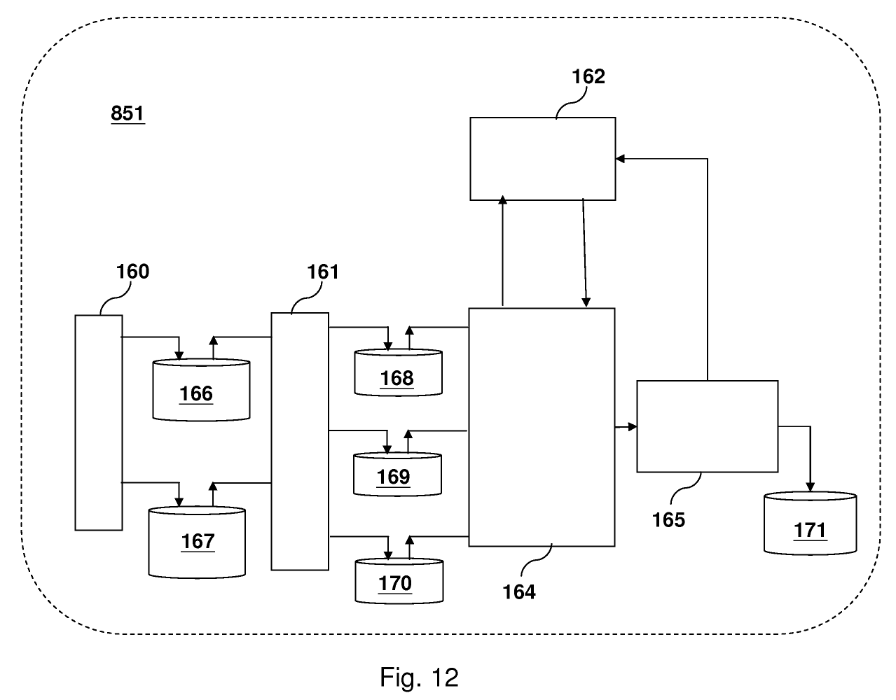

In the present implementation, the Polymorphic Genetic Metaheuristic Optimization system 851 further comprises multiple modules as shown in FIG. 12. It comprises a data collection module 160 that collects both the input signals and target signals. These signals are stored in the input signal database 166 and target signal database 167 respectively. The data processing module 161 performs the data processing method as shown in FIG. 3 and partitions the data into the training, validating and testing sets. They are stored in the training database 168, the validating database 169 and testing database 170 respectively. Neural Network Module 164 first constructs a population of parent neural networks as described in FIG. 4, and stores the corresponding parent chromosomes in the genetic programming module 162. Afterwards, this module 164 trains up the parent neural networks utilizing the training database 168, the validating database 169 and the testing database 170. In a preferred embodiment, the neural network module 164 incorporates the Matlab Neural Network Toolbox from Mathworks. The fitness evaluation module 165 calculates fitness scores for the parent neural networks and stores the best performers to the Top-B database 171. Meanwhile, the genetic programming module 162 creates a population of child chromosomes by applying genetic operators to the parent chromosomes using the flow-model shown in FIG. 8. Afterwards, this module will copy the child chromosomes to the parent chromosomes and another generation of neural training, fitness evaluation and chromosome modification begins until the total number of generation is reached. Once this is achieved, the Top-B database 171 stores a set of neural networks that performs the mapping transformation well. An optimal neural network with the best fitness score can then be chosen from this database.

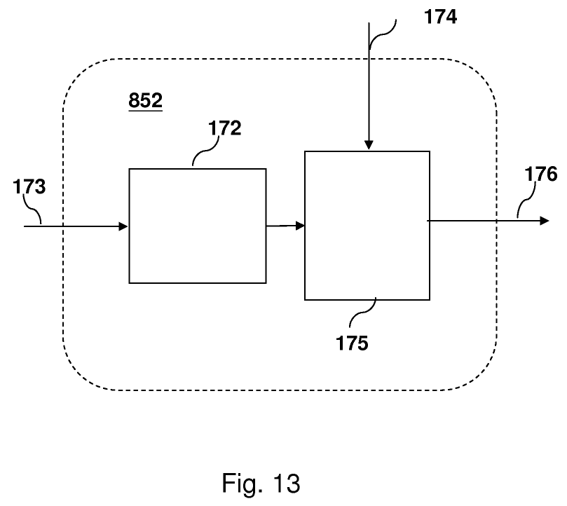

In one implementation, the optimal neural network can be retrieved from the Top-B database 171 and embeds into the signal mapping system 852. In one embodiment, both systems 851 and 852 can reside in the same data processing system 800 as separate software applications. In another embodiment, system 852 can be a stand-along application run on a separate data processing device 800. In yet another embodiment, system 852 can be embedded into an apparatus that comprises a second hardware module with CPU 810 and memory 811. Exemplary examples of such apparatus are a piece of medical equipment, an X-ray machine, a magnetic resonant imaging device, a digital camera, a digital telescope, a piece of audio equipment, a MP3 player, or an electronic device. FIG. 13 further illustrates the essential components of the signal mapping system 852. It comprises a data handling module 172 that accepts input signal 173. Module 172 also carries out the data processing functions performed by module 162 of system 851 before feeding it to the neural network processing module 175. Module 175 further accepts parameter setting input 174. Input 174 also connects to at least one input node of the optimal neural network. The neural network processing module 175 transforms the input signal 173 to an output signal 176, using the optimal neural network obtained from the Polymorphic Metaheuristic Optimization System 851. For the same input signal 173, a user can input different values to the parameter setting input 174 so that the neural network processing module 175 will product a different output signals 176. As an exemplary scenario, the optimal neural network is to transform a dark digital image taken from a digital camera to a bright image; the parameter setting 174 may consists of the ISO speed range, the aperture value, the shutter speed setting, or any combination thereof. By specifying different values to the parameter setting input 174, the neural network processing module 175 can product different output images with different degree of brightness.

In one embodiment, the neural network processing module 175 is the same as the neural network module 164. In an alternative embodiment, module 175 can be a simplified version of module 164, as it is not necessary to include the training function in 175 because the optimal neural network has already been trained by system 851. Hence the software code size of the signal mapping system 852 can be reduced. This is advantageous when system 852 is chosen to embed to an apparatus with limited program memory space.

It should be understood for those skilled in the art that the division between hardware and software is a conceptual division for ease of understanding and is somewhat arbitrary. Moreover, it will be appreciated that peripheral devices in one computer installation may be integrated to the host computer in another. Furthermore, the Polymorphic Genetic Metaheuristic Optimization system 851 and the signal mapping system 852 may be executed in a distributed computing environment so that some of the modules in this system are executed in one computer while others are performed in others. The software programs and the related databases can be stored in a separate file server or database server and are transferred to the local host for execution. The data processing system 800 as shown in FIG. 11 is therefore an exemplary embodiment of how the present invention can be implemented. Those skilled in the art will appreciate that alternative embodiments can be adopted to implement the present invention.

In yet another embodiment, the systems 851 or 852 may be implemented on an article of manufacture in hardware, firmware or software, or any combination thereof. The program code and its associated data structures, can be stored either in an Integrated Circuit (IC) chip, a Programmable Gate Array (PGA), an Application Specific Integrated Circuit (ASIC), etc, or in a computer readable media such as magnetic media storage, optical media storage, volatile or non-volatile memory.

### 4. Examples

The method disclosed from this invention has been used to develop a generic imaging filter and mask system to simulate an artificial camera and lens. The resultant imaging system is capable of accurately redeveloping a photograph as if it were taken using different original settings by means of learned, observational prediction. Enabling features include: refocusing picture elements; altering aperture settings; differential lens materials, e.g. Glass lens to predicting how a picture would look like if taken through a more superior quality gem stone lens.

The specific example given here is to transform a camera image taken with the ISO and aperture settings offset that restricts the ideal amount of light hitting the CMOS sensors (resulting in a darkened image) to an image taken under ideal conditions.

To do so, a set of digital images is collected. In this example, the Canon EOS-1D Mark II N digital camera is used. Firstly, the camera is fitted with the Cannon glass lens Canon EF 24 mm f/2.8, and a plurality of images are taken and recorded on multiple scenes, each with different ISO speed ranges, shutter speeds, aperture values, and focal point settings. A large number of images are collected and these are the input signals to the system. Next, the camera is fitted with the Canon EF 24 mm f 1.4L USM high-quality gem stone lens and another plurality of images is taken in a similar process. This becomes the target signals for the system. Afterwards, the image data set is examined, and any unknown values are fixed. Each image data comprises not only the RGB pixel values, but also the ISO, aperture, shutter speed, and focal point settings when this image is taken as well as other information such as the histograms of the image as mentioned in previous paragraphs. This data is stored in matrices and the data process function of normalizing the row values to between −1 and +1 (step 24 in FIG. 3) is applied to them. Afterwards, the entire data set is partitioned into the training set, the validating set and the test set.

After data collection and processing, the data set is ready for training. The following global training parameters are used in this example:

TABLE 6

| Parameters | Description | Value |
|---|---|---|
| S | Maximum number of nodes allowed for | 1,000,000 |
| | each neural network | |
| N | Number of neural networks in a population | 20 |
| G | Number of generations | 1000 |
| B | Number of best models | 10 |
| T | Number of training cycles for neural | 100 |
| | network training | |

The system will then execute the flow steps in FIG. 2 to create the parent neural networks (step 11), choose a training method (step 12) to train them (step 13), and then evolve these neural networks (steps 14 and 15) until the total number of generations has been reached. Afterwards, the neural network in the Top-B set that achieves the lowest fitness score is retrieved to be the optimal neural network for this task. In this example, the task is to change the brightness of a digital image to one that would have been taken from a different ISO speed or aperture setting.

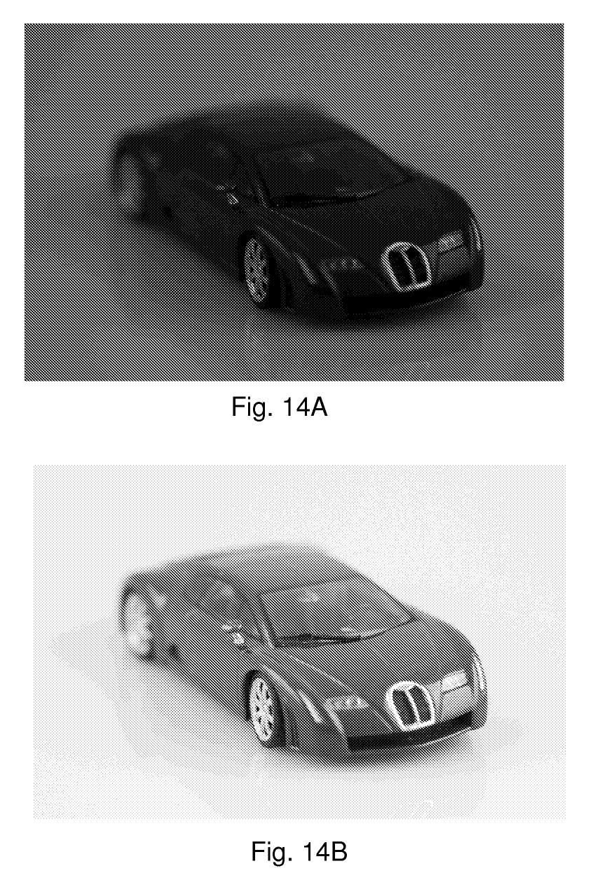

The optimal neural network can then be used by the signal mapping system 852 for signal enhancement application. In this example, an input image as shown in FIG. 14A is fed to the data handling module 172 of the signal mapping system 852. The desired aperture and ISO settings can also be input to the parameter setting input 174. The neural network processing module 175 can then perform the mapping transformation and produce an output image as shown in FIG. 14B. It should be noted that the original images are color images but they are converted to black-and-white images in this document. As can be clearly seen in these two images, FIG. 14A is an image taken with poor ISO, Aperture settings, and the mapping transformation converts this image to the one in FIG. 14B which more closely resembles an “ideal” image.

It should be appreciated that while the input and target images are taken at discrete values of ISO, aperture and focal point settings, a system developed according to the present invention may also be capable of creating output images at values that are outside these discrete settings. As an example, the camera lens may only offer discrete F-stop settings of 2.0, 2.8 . . . etc. But the system may be trained to have the capability to simulate an output image with a continuous aperture setting (for example, F-stop of 2.55). In this sense, the resultant neural network can simulate a digital image that would not have been possibly taken by a physical camera lens with discrete parameter settings. Furthermore, by supplying different aperture and ISO values to the parameter setting input 174, system 852 can produce a plurality of output images from the same input image, each displaying a different brightness property. A user can then change the parameter setting values, observe the effects on the output images, and then select the one that is deemed most appropriate for his application.

Although this example illustrates how the system can derive a mapping transformation to map an input image to different aperture and ISO settings, other image enhancement and manipulation operations can also be done. For example, it is possible to use the present invention to simulate how an image would have looked if taken by an expensive, high-quality camera lens, when in effect it is taken by an ordinary, inexpensive lens. Since high-quality camera lenses produce images with less noise, the resultant transformation not only provides better color quality but also better clarity. Similarly, the same approach can be used in medical imaging applications to enhance the quality of those images taken by medical instruments.

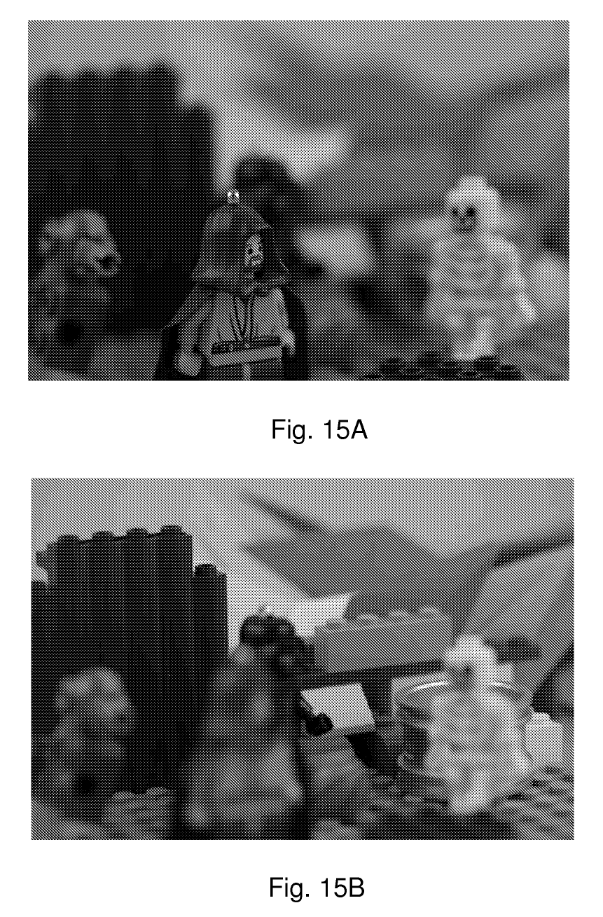

Another application of the present invention is to re-focus the object in the image. FIG. 15A is the original image and FIG. 15B is the output image after sending the original one to a properly designed neural network. (Again, the original images are full color images but are converted to black-and-white here.) Notice that the blurred background of the original image becomes clearer as the foreground object becomes de-focused. The neural network of the present invention for this re-focus application is trained in a similar fashion as discussed in the example above. The only difference is that it is trained on input and target images with different focal point settings. Hence the system is asked to find an optimum neural network to perform the re-focusing task in this case, whereas in the previous example, the system is given a task to find a mapping transformation for different ISO, aperture settings.

### 5. Other Applications and Variations

The flexibility of this system is thus demonstrated. It should be emphasized that the same generic method of using genetic programming to evolve neural networks can be used to find the suitable mapping transformation for a variety of signal enhancement and transformation applications. Although image enhancement and transformation is used as examples, it should be obvious to those skilled in the art that the same approach can be used in analyzing and transforming other signals, including audio, speech, time-series data, financial data, video clips, spectral data, and electromagnetic waves . . . etc. In each of these signal categories, the present invention can be used to design specific signal enhancement tasks. For speech or audio signal, it may be used for background noise reduction, spectral shaping, or audio source separation. In addition, this inventive method may be extended to other application domains such as pattern recognition, trend analysis or process control.

The preferred embodiments of the present invention are thus fully described. Although the description refers to particular embodiments, it will be clear to one skilled in the art that the present invention may be practiced with variation of these specific details. Hence this invention should not be construed as limited to the embodiments set forth herein.

For example, although the discussion focuses on representing image data in three data layers, it should be appreciated that this is only an exemplary method of organizing the input signal and target signal data set. In other applications, different types of information can be collected, and different signal processing and transformation techniques such as the wavelet transform can be applied to the raw data to extract useful information. Moreover, there are many other methods to clean up and replace unknown or erroneous data.

It is clear to one skilled in the art that many other data processing methods can be adopted based on the teaching of the present invention. In particular, those methods that apply to a row of the data matrix can also be used to process columns of data matrices, and vice versa. Although two-dimensional image data stored in data matrices are used to teach the data processing steps in this invention, it should be appreciated that other data formats more amenable to represent the input and target signals at hand can be used. Likewise, the transfer functions in Table 2 and weight functions in Table 3, as well as the training functions in Table 4 are exemplary lists of functions that can be adopted by this invention. These functions can be suitably combined when possible, and new functions can be added to each function category to extend the versatility of this system.

Although mean square error is mentioned as a measure of the total error between the output response and the target signal in neural training, other forms of measurements such as mean absolute error or the sum-of-square error can also be used. On the other hand, there may be other neural training methods that attempt to maximize a certain measurement. When such measurement is used as fitness score, a higher fitness score means better performance. Hence an optimal neural network in this case is the one that maximize the fitness score.

The genetic programming implementation in this invention differs in many ways to those practices by others. They have been found to be advantageous over the others. Based on the teaching disclosed here, those skilled in the art can extend the inventive ideas in many ways but they will still fall into the scope of this invention. For example, the structure of the chromosome as shown in FIGS. 6A and 6B can be extended to cover more than two chromosome layers, and other data structures such as an array of bits, a tree structure can be used, singly or in combination with tables and matrices. Furthermore, different probability values can be assigned to the genetic operators and those shown in Table 5 is only one exemplary choice. Likewise, the probability values disclosed for the mutated clone method, the crossover method and the mutated crossover method are chosen for the present implementation but other choices can be used for different applications.

It should also be appreciated that although the discussions teaches these operations in details by way of specific implementation examples, the principle ideas of applying constraints to the mutation and crossover operations can be realized and extended in many ways. While the teaching discusses the procedure where the crossover method generates one child chromosome from two parents, it is entirely feasible to extend this method to generate more than one child chromosomes. Those skilled in the art can also appreciate that new constraints can be put in to weed out child chromosomes that are unlikely to succeed. Moreover, the suggested method of choosing the chromosome candidates for genetic operations is a simple but effective way that actually improves the overall performance of genetic neural training. Although the example suggests choosing 4 candidates, this number is only an illustrative example and other values can be used as well. Likewise, those skilled in the art can also devise other ways to choose the second candidate.

What is claimed is:

1. A method of deriving a mapping transformation that transforms an input signal obtained from a subject under a first value of a parameter to an output signal obtainable from said subject under a second value of said parameter, comprising the steps of:
a) creating a plurality of neural networks; each of said neural network comprising a plurality of nodes arranged in neural layers being connected by a plurality of weighted synaptic links; each said node further comprising a plurality of computational functions randomly selected from a plurality of functions in a plurality of function categories;
b) storing the configurations of said plurality of neural networks to a plurality of chromosomes; said configurations recording the connections of said weighted synaptic links among nodes and said computational functions of each said nodes in at least one chromosome layer;
c) performing a first training on said plurality of neural networks by adjusting said weighted synaptic links to learn said mapping transformation using a data set; said data set comprising a set of said input signals and a set of target signals; said target signal obtained from said subject using a value of said parameter different from said input signal;
d) performing a second training on said plurality of neural networks by modifying said configurations of said plurality of neural networks, comprising the steps of:
i) applying genetic operators to said plurality of chromosomes, thus creating a second plurality of neural networks with different configurations;
ii) discarding neural networks in said second plurality of neural networks that do not satisfy at least one pre-defined constraint;
iii) repeating steps (i) and (ii) to replenish said discarded neural networks, and
iv) replacing said plurality of neural networks by said second plurality of neural networks, and
e) repeating steps (c) and (d) for a pre-determined number of generations such that in each said generation the configuration of each neural network may be altered and selected flexibly by said genetic operators to derive at an optimal neural network for said mapping transformation.

2. A method according to claim 1 wherein said signal is an image taken from an image sensor and said parameter is the:
a) aperture setting;
b) shutter speed;
c) exposure parameter;
d) focal point;
e) pixel density;
f) optical lens parameter, or
g) any combination thereof.

3. A method according to claim 2 wherein said image is:
a) an ultra-sound image;
b) a magnetic resonant image;
c) a computer tomography image;
d) an X-ray image;
e) a gamma ray image;
f) an infra-red image, or
g) an image from digital camera.

4. A method according to claim 1 wherein said signal is an audio signal taken from an audio sensor and said parameter is:
a) spectral response of said audio sensor;
b) direction of audio source incoming to said audio sensor, or
c) any combination thereof.

5. A method according to claim 1 wherein said signal is a video signal comprising a sequence of images and an audio sensor to record an audio signal, and said parameter further comprises:
a) number of images per second;
b) spectral response of said audio sensor;
c) segmentation boundaries of said video signal; said boundaries grouping said video signal into video segments, or
d) any combination thereof.

6. A method according to claim 1 wherein said plurality of function categories further comprises a transfer function category, a weight function category and a bias function category, with each category having a plurality of corresponding functions; said creating step further comprising the steps of choosing a transfer function from said transfer function category, choosing a weight function from said weight function category and choosing a bias function from said bias function category.

7. A method according to claim 1 further comprising the steps of arranging said chromosome in more than one chromosome layer, said chromosome comprising:
a) a first chromosome layer with a plurality of chromosome tables to record said connections of said weighted synaptic link among nodes; each said chromosome table comprising a plurality of rows and a plurality of columns, with a non-zero table element in said chromosome table denoting that there is a connection between said row and said column while a zero entry denoting an absence of said connection, and
b) a second chromosome layer arranged in a chromosome matrix with a plurality of rows and columns of matrix elements; each column representing one neural layer of said neural network, the first row recording the number of nodes in each said neural layer; and the other rows representing one of said function categories; and each matrix element in said other rows denoting the choice of said plurality of functions in said function category.

8. A method according to claim 1 wherein said at least one constraint is the maximum number of nodes allowed in a neural network.

9. A method of producing a transformed output signal from a sampled input signal, said transformed output signal obtainable of a pre-selected subject under a pre-determined value of a parameter, said sampled input signal obtained of said pre-selected subject under a pre-selected value of said parameter, said method comprising the steps of:
a) providing an optimal neural network derived using a method of deriving a mapping transformation that transforms an input signal obtained from a subject under a first value of a parameter to an output signal obtainable from said subject under a second value of said parameter, said method of deriving comprising the steps of:
i) creating a plurality of neural networks; each of said neural network comprising a plurality of nodes arranged in neural layers being connected by a plurality of weighted synaptic links; each said node further comprising a plurality of computational functions randomly selected from a plurality of functions in a plurality of function categories;
ii) storing the configurations of said plurality of neural networks to a plurality of chromosomes; said configurations recording the connections of said weighted synaptic links among nodes and said computational functions of each said nodes in at least one chromosome layer;
iii) performing a first training on said plurality of neural networks by adjusting said weighted synaptic links to learn said mapping transformation using a data set; said data set comprising a set of said input signals and a set of target signals; said target signal obtained from said subject using a value of said parameter different from said input signal;
iv) performing a second training on said plurality of neural networks by modifying said configurations of said plurality of neural networks, comprising the steps of:
(1) applying genetic operators to said plurality of chromosomes, thus creating a second plurality of neural networks with different configurations;
(2) discarding neural networks in said second plurality of neural networks that do not satisfy at least one pre-defined constraint;
(3) repeating steps (i) and (ii) to replenish said discarded neural networks, and
(4) replacing said plurality of neural networks by said second plurality of neural networks, and
v) repeating steps (c) and (d) for a pre-determined number of generations such that in each said generation the configuration of each neural network may be altered and selected flexibly by said genetic operators to derive at said optimal neural network for said mapping transformation;
b) feeding said sampled input signal to said optimal neural network;
c) entering said pre-determined value of said parameter to said optimal neural network, and
d) performing said mapping transformation to produce said transformed output signal.

10. A method for deriving a mapping transformation that transforms an input signal to a target signal comprising the steps of:
a) collecting a data set, said data set further comprising a set of said input signals and a set of said target signals; wherein each of said target signal indicating the desired output response of said mapping transformation for said input signal;
b) creating a plurality of neural networks; each of said neural network comprising a plurality of nodes arranged in neural layers being connected by a plurality of weighted synaptic links;
c) randomly selecting computational functions for said nodes from a plurality of functions in a plurality of function categories;
d) storing the configurations of said plurality of neural networks to a plurality of chromosomes; said chromosomes further comprising at least one chromosome layer;
e) training said plurality of neural networks to learn said mapping transformation by adjusting the weight values of said weighted synaptic links so that a fitness score can be optimized; said fitness score measuring the mapping transformation performance of said neural network;
f) modifying said configurations of said plurality of neural networks by repetitively performing the steps of:
i) selecting at least one candidate chromosome from said plurality of chromosomes according to a pre-specified criteria;
ii) generating at least one child chromosome by a genetic operator, and
iii) applying at least one global constraint to said child chromosome and repeating steps (i) and (ii) if said child chromosome fails to satisfy said at least one constraint
so that a plurality of child chromosomes can be generated; said plurality of child chromosomes defining said configurations of said plurality of neural networks, and
g) repeating steps (e) and (f) for a predetermined number of generations such that in each said generation the configuration of each neural network may be altered and selected flexibly by said genetic operator to derive at an optimal neural network for said mapping transformation.

11. A method according to claim 10 further comprising the steps of organizing said data set into a plurality of data layers wherein a first data layer stores digitized values of said input signal and said target signal; a second data layer stores said conditions under which said digitized values are obtained and a third data layer stores additional information and data derived from said first data layer and second data layer.

12. A method according to claim 11 further comprising a data processing to operate on said data set, said data processing step selecting from a group consisting of:
a) fixing any unknown values in said data set;
b) normalizing the values of said data set to a prescribed range;
c) normalizing the values of said data set to satisfy a prescribed statistical property;
d) performing mathematical transformation on values of said first data layer and storing results to said third data layer;
e) removing data in said data set with constant values, and
f) partitioning said data set into training set, validating set and testing set; each comprising a plurality of input signals and a plurality of corresponding target signals.

13. A method according to claim 12 wherein said mathematical transformation is selected from a group consisting of:
a) a method to perform Principle Component Analysis (PCA);
b) a method to perform wavelet transformation;
c) a method to perform Fourier transformation;
d) a method to perform hierarchical cluster analysis;
e) a method to perform k-means cluster analysis, and
f) a method to compute the logarithmic values of said first data layer.

14. A method according to claim 1 wherein said plurality of function categories further comprises a transfer function category, a weight function category and a bias function category with each category having a plurality of corresponding functions; said randomly selecting step further comprising the steps of choosing a transfer function from said transfer function category, choosing a weight function from said weight function category and choosing a bias function from said bias function category.

15. A method according to claim 14 wherein said choosing transfer function step comprising the step of choosing one transfer function from a group consisting of:
a) competitive transfer function;
b) hard limit transfer function;
c) symmetric hard limit transfer function;
d) log-sigmoid transfer function;
e) inverse transfer function;
f) positive linear transfer function;
g) linear transfer function;
h) radial basis transfer function;
i) saturating linear transfer function;
j) symmetric saturating linear transfer function;
k) softmax transfer function;
l) hyperbolic tangent sigmoid transfer function, and
m) triangular basis transfer function.

16. A method according to claim 14 wherein said choosing weight function step comprising the step of choosing one weight function from a group consisting of:
a) convolution weight function;
b) Euclidean distance weight function;
c) dot-product weight function;
d) Manhattan distance weight function;
e) negative distance weight function;
f) normalized dot-product weight function, and
g) scalar product weight function.

17. A method according to claim 14 wherein said choosing bias function step comprising the step of selecting one bias function from a group consisting of:
a) product bias function, and
b) sum bias function.

18. A method according to claim 10 wherein said nodes further comprising input nodes that receives input signal; output nodes that sends out output responses, and nodes and said training step further comprising the steps of:
a) choosing a specific training function from a plurality of training functions;
b) inputting said set of input signals to said input nodes of said neural network;
c) computing said set of output responses by propagating said set of input signals from said input nodes to said output nodes via said plurality of weighted synaptic links;
d) accumulating the total error between said set of output responses and said set of target signals;
e) invoking said specific training algorithm to adjust said weight values of said weighted synaptic links to minimize said total error;
f) calculating said fitness score; said fitness score being related to said total error, and
g) repeating steps (b), (c), (d), (e) and (f) for a pre-determined number of iterations unless said fitness score is smaller than a pre-defined criterion.

19. A method according to claim 18 wherein said choosing step comprising the step of choosing one training function from a group consisting of:
a) batch training with weight and bias learning rules;
b) Broyden-Fletcher-Goldfarb-Shanno quasi-Newton backpropagation;
c) Bayesian regularization;
d) cyclical order incremental update;
e) Powell-Beale conjugate gradient backpropagation;
f) Fletcher-Powell conjugate gradient backpropagation;
g) Polak-Ribiére conjugate gradient backpropagation;
h) Gradient descent backpropagation;
i) Gradient descent with adaptive learning rule backpropagation;
j) Gradient descent with momentum backpropagation;
k) Gradient descent with momentum and adaptive learning rule backpropagation;
l) Levenberg-Marquardt backpropagation;
m) One step secant backpropagation;
n) Resilient backpropagation;
o) Scaled conjugate gradient backpropagation;
p) Sequential order incremental training with learning functions, and
q) Random order incremental training with learning functions.

20. A method according to claim 10 wherein a Top-B set is created to store a plurality of high performance neural networks; said training step further comprising the step of replacing at least one said high performance neural network from said Top-B set by at least one said plurality of neural networks if the fitness score of said at least one said plurality of neural network is better than the corresponding fitness score of said at least one said high performance neural network.

21. A method according to claim 10 wherein said pre-specified criteria of selecting at least one candidate chromosome further comprising the steps of:
a) randomly selecting a plurality of chromosomes to form a plurality of chromosome candidates, and
b) selecting said candidate chromosome from said plurality of chromosome candidates that has the best fitness score.

22. A method according to claim 21 further comprising the step of selecting another candidate chromosome from said plurality of chromosome candidates at random.

23. A method according to claim 22 further comprising the steps of arranging said chromosome in more than one chromosome layer, said chromosome comprising:
a) a first chromosome layer with a plurality of chromosome tables to record said connections of said weighted synaptic link among nodes; each said chromosome table comprising a plurality of rows columns of table elements, with a non-zero table element in said chromosome table denoting that there is a connection between said row and said column while a zero entry denoting an absence of said connection, and
b) a second chromosome layer arranged in a chromosome matrix with a plurality of rows and columns of matrix elements; each column representing one neural layer of said neural network, the first row recording the number of nodes in each said neural layer; and the other rows representing one of said function categories; and each matrix element in said other rows denoting the choice of said plurality of functions in said function category.

24. A method according to claim 23 wherein said generating step in step 1 further comprising the step of choosing one genetic operator from a group consisting of:
a) clone method;
b) mutated clone method;
c) crossover method, and
d) mutated-crossover method.

25. A method according to claim 24 wherein said clone method comprising the step of copying said candidate chromosome to said child chromosome.

26. A method according to claim 24 wherein said mutated clone method further comprising the steps of:
a) randomly selecting a plurality of table elements from said candidate chromosome;
b) swapping said table element values between one and zero, and
c) copying the rest of those candidate chromosome elements not selected to said child chromosome.

27. A method according to claim 24 wherein said mutated clone method further comprising the steps of:
a) randomly selecting a plurality of matrix elements from said candidate chromosome;
b) replacing said matrix element with a different value, said different value being an index to a function in the same function category that said matrix element belongs to, and
c) copying the rest of those candidate chromosome elements not selected to said child chromosome.

28. A method according to claim 24 wherein said crossover method further comprising the steps of creating at least one child chromosome by:
a) choosing a first candidate chromosome and a second candidate chromosome;
b) randomly selecting a first crossover position in said first candidate chromosome; and a second crossover position in said second candidate chromosome; said first crossover position partitioning said first candidate chromosome into two parts; and said second crossover position partitioning said second candidate chromosome into two parts;
c) creating said at least one child chromosome by randomly concatenating one part of said first candidate chromosome to another part of said second candidate chromosome, and
d) reconstructing said plurality of chromosome tables of said at least one child chromosome by deleting those entries indicating connecting synaptic links to non-existing nodes in said child chromosome.

29. A method according to claim 28 further comprising a crossover mutation method, comprising the steps of
a) randomly identifying at least one matrix element from said at least one child chromosome, and
b) replacing said at least one matrix element by a second matrix element with a value selected from the value found in the matrix elements of the corresponding row of said first and second chromosome candidates.

30. A method according to claim 24 wherein said mutated crossover method further comprising the steps of creating at least one child chromosome; comprising the steps of:
a) choosing a first candidate chromosome and a second candidate chromosome;
b) randomly selecting a first crossover position in said first candidate chromosome; and a second crossover position in said second candidate chromosome; said first crossover position partitioning said first candidate chromosome into two parts and said second crossover position partitioning said second candidate chromosome into two parts;
c) creating said at least one child chromosome by randomly concatenating one part of said first candidate chromosome to another part of said second candidate chromosome;
d) reconstructing said plurality of chromosome tables of said at least one child chromosome by deleting those entries indicating connecting synaptic links to non-existing nodes in said child chromosome;
e) randomly selecting a plurality of table elements from said at least one child chromosome;
f) swapping said table element values between one and zero;
g) randomly selecting a plurality of matrix elements from said at least one child chromosome, and
h) replacing said matrix element with a different value, said different value being an index to a function in the same function category that said matrix element belongs to.

31. A method according to claim 10 wherein said applying global constraint step further comprising the step of checking if the total number of nodes in said neural network constructed from said child chromosome is not more than a pre-specified number.

32. A computer system for deriving a signal transformation that transforms an input signal obtained from a subject under a first value of a parameter to an output signal obtainable from said subject under a second value of said parameter, comprising:
a) a data collection module configured to store a data set; said data set further comprising a plurality of input signals and a plurality of target signals;
b) a data processing module configured to prepare said data set for subsequent analysis;
c) a neural network module configured to
i) construct a plurality of neural networks; each said neural network comprising a plurality of nodes interconnected by a plurality of weighted synaptic links; the configurations of said neural networks being stored in a plurality of chromosomes, and
ii) train said plurality of neural networks to learn said signal transformation using said plurality of input signals and said plurality of target signals;
d) a fitness evaluation module configured to evaluates the performances of said plurality of neural networks in performing said signal transformation; and stores those neural networks having high performance to a Top-B database, and
e) a genetic programming module configured to modify said configurations of said plurality of neural networks by repetitively performing the steps of
i) selecting at least one candidate chromosome from said plurality of chromosomes according to a pre-specified criteria;
ii) generating at least one child chromosome by a genetic operator, and
iii) applying at least one global constraint to said child chromosome and repeating steps (i) and (ii) if said child chromosome fails to satisfy said at least one constraint
so that by repetitively executing said genetic programming module, said neural network module and said fitness evaluation module, the performances of said plurality of neural networks improve and an optimal neural network configuration can be retrieved from said Top-B database that achieves the best performance in performing said signal transformation.

33. An article of manufacture for signal enhancement of a signal processing apparatus comprising:
a) a data handling module configured to accept an input signal and prepare said input signal for subsequent analysis, and
b) a neural network processing module comprising at least one neural network, each said neural network optimally trained to transform an input signal of a subject to an output signal of said subject according to at least one pre-determined parameter value; said at least one pre-determined parameter value inputting to at least one input node of said neural network.
